(19) United States
(12) Patent Application Publication
(10) Pub. No.: US 2012/0162634 A1
(43) Pub. Date: Jun. 28, 2012

(54) SPEED SENSOR

(75) Inventors: Wolfgang Jöckel, Gersfeld (DE); Martin Haverkamp, Frankfurt (DE); Stephan Risch, Weiterstadt (DE); Bernhard Schmid, Friedberg (DE); Thomas Zuccaro, Bad Soden (DE)

(73) Assignee: CONTINENTAL TEVES AG & CO. oHG, Frankfurt (DE)

(21) Appl. No.: 13/382,971

(22) PCT Filed: Jul. 19, 2010
(86) PCT No.: PCT/EP10/60418

§ 371 Date: Mar. 16, 2012

(30) Foreign Application Priority Data
Jul. 22, 2009 (DE) 10 2009 034 485.3

(51) Int. Cl. G01P 3/36

(52) U.S. Cl. 356/28.5; 356/27

(57) ABSTRACT

A sensor for sensing speeds, at least including a sensor unit, which has a radiation emitter element, a sensor element, a preliminary optical element and an evaluation circuit, a sensor housing, which has a leadframe, and a dirt guard unit, which includes a lens, wherein the sensor unit is in electrical contact with the leadframe of the sensor housing, and the lens of the dirt guard unit caps off the sensor housing as a cover.

### CROSS REFERENCE TO RELATED APPLICATIONS

This application is the U.S. National Phase Application of PCT International Application No. PCT/EP2010/060418, filed Jul. 19, 2010, which claims priority to German Patent Application No. 10 2009 034 485.3, filed Jul. 22, 2009, the contents of such applications being incorporated by reference herein.

### FIELD OF THE INVENTION

The invention relates to a sensor for sensing speeds and to the use thereof in motor vehicle, particularly as an optical speed sensor.

### BACKGROUND OF THE INVENTION

The invention is based particularly on the aspect of proposing a sensor, the sensing principle of which is based on electromagnetic radiation, which operates precisely and/or reliably and/or is relatively inexpensive.

### SUMMARY OF THE INVENTION

The invention achieves this aspect by means of the sensor, which has a radiation emitter element, a sensor element, a preliminary optical element and an evaluation circuit, a sensor housing, which has a leadframe, and a dirt guard unit, which comprises a lens, wherein the sensor unit is in electrical contact with the leadframe of the sensor housing, and the lens of the dirt guard unit caps off the sensor housing as a cover.

The speed sensor is preferably in the form of a sensor type which is also called a speed over ground sensor.

The radiation emitter element preferably emits electromagnetic radiation and the sensor element preferably senses electromagnetic radiation.

Preferably, the lens of the dirt guard unit or the preliminary optical element or the lens of the dirt guard unit and the preliminary optical element are in the form of a liquid lens, particularly with an electrically adjustable focal length.

It is preferred for the lens of the dirt guard unit or the preliminary optical element or the lens of the dirt guard unit and the preliminary optical element to have a liquid crystal layer which can be actuated as an optical closure or optical shutter, in particular, or is of corresponding design.

As an alternative preference, the lens of the dirt guard unit or the preliminary optical element or the lens of the dirt guard unit and the preliminary optical element are in the form of disks and do not concentrate and do not scatter the electromagnetic radiation or the light.

The sensor unit is preferably in the form of a surface-mounted device, SMD.

The radiation emitter element is preferably in the form of a laser which, in particular, is designed such that it operates on the basis of the self-modulating interference principle, SMI. In particular, reflected portions of the emitted laser beam modulate particularly their own laser power, as a result of which a speed is measured on the basis of this self-modulation. In this case, the sensor element is particularly preferably not of separate design but rather is part of the laser or lasers itself/themselves.

The sensor element of the sensor unit is preferably integrated in the radiation emitter element, particularly as a photodiode.

The sensor housing preferably has a mounting unit for mounting the entire sensor, and also a connector unit, the contact pins of which are electrically conductively connected to the leadframe.

The dirt guard unit preferably comprises a tube. This tube is expediently mounted on the sensor housing by means of a mechanically removable and closable closure, particularly a clip closure and/or at least one snap-action clasp.

The tube on the dirt guard unit expediently contains a disk opposite the lens so that no dirt can penetrate to the lens. This disk is arranged particularly in the region of the mounting on the sensor housing, for example at least in the first third in relation to the tube length.

It is preferred for the tube to be designed to be at least three times as long, particularly at least five times as long, as the diameter of the lens.

The sensor unit preferably comprises an electronic self-test device which, to this end, has an additional sensor element.

The sensor is preferably designed such that the sensor unit comprises at least one laser which emits electromagnetic radiation, and the electromagnetic radiation reflected and/or scattered and/or refracted by a roadway and/or by objects situated thereon is sensed by the sensor unit again, particularly through self-modulation.

The sensor is preferably integrated in a motor vehicle and oriented such that it senses the roadway or a section of the roadway, particularly ahead of the motor vehicle.

The sensor preferably comprises a plurality of lasers which are directed at the roadway and which are arranged collectively in the sensor unit, said lasers particularly preferably requiring different operating intervals (focusing), depending on the demands of the application.

The lens is expediently connected by a suitable welding method to the sensor housing, which is made from plastic, in particular, so that the lens is positioned above or in front of the sensor unit with one or more beam paths. As a result, the lens positioned downstream deflects the beam path into the intended direction, focuses the latter, determines the operating interval and simultaneously serves as a cover for the sensor housing.

As an alternative preference, the lens and/or the preliminary optical element are in the form of a liquid lens. A liquid lens is understood to mean particularly an optical lens with an electrically variable focal length. This particularly preferably produces an autofocus function and/or an electrically adjustable operating interval. This operating interval can be dynamically adapted, for example depending on the loading condition of the vehicle. The operating interval can be measured by an additional functionality of the sensor component.

The sensor preferably comprises a self-test function. For this, the sensor has particularly an electronic self-test device, which can also be integrated in a different or general electronic circuit of the sensor, for example. Furthermore, the sensor particularly preferably additionally has an additional sensor element which is designed and arranged such that it senses the attenuation of radiation (loss of intensity) in the sensor housing. The at least one laser, as part of the sensor unit, expediently senses the alteration in the beam path for self-test purposes itself. Preferably, the complete optical beam path, including the processing electronics, is checked in this manner. This self-test function is used to detect and indicate that it is necessary to replace the dirt guard unit or the tube, for example. On account of the modular design, the dirt guard unit or the tube can then be changed without needing to replace the complete sensor.

The sensor is expediently of modular design, where the sensor unit, the sensor housing and the dirt guard unit form prefabricated modules. By way of example, this allows the sensor to be assembled with few individual parts while simultaneously focusing and aligning the optical system.

The lens of the dirt guard unit and/or the preliminary optical element are preferably in the form of conventional optical elements or optical lenses or, as an alternative preference, in the form of liquid lenses.

As an alternative preference, it is possible for the sensor housing to be designed to have press-in contacts, on which a printed circuit board with an SMD sensor, which has one or more lasers (SMI), is mechanically mounted and has electrical contact made with it. The mounting unit can alternatively be designed as a latching element. The connector can alternatively be designed as a cable outlet.

The invention also relates to the use of the sensor in motor vehicles, particularly as an optical speed sensor for the absolute and relatively precise measurement of speed in motor vehicles, particularly preferably as what is known as a speed over ground sensor.

### BRIEF DESCRIPTION OF THE DRAWINGS

The invention is best understood from the following detailed description when read in connection with the accompanying drawings. Included in the drawing is the following figures:

FIG. 1 shows an exemplary sensor,

FIG. 2 shows an exemplary sensory housing, an exemplary, sensor unit and an exemplary lens of the dirt guard unit, as a separate sensor,

FIG. 3 shows an exemplary housing portion for the insertion of a leadframe based on the example,

FIG. 4 shows a sensor based on the example without a lens, and

FIG. 5 shows an exemplary embodiment of a sensor having a tube as part of the dirt guard unit.

### DETAILED DESCRIPTION OF PREFERRED EMBODIMENTS

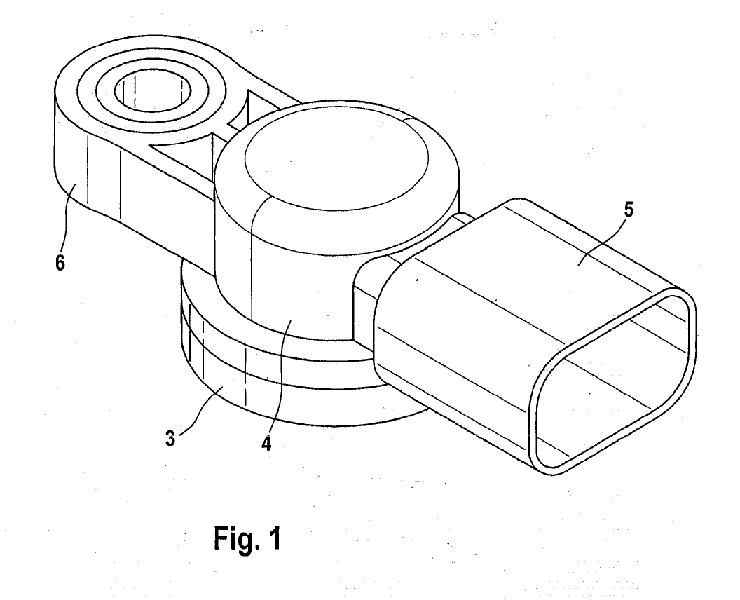

The sensor shown in FIG. 1 by way of example comprises a sensor housing 4 having a connector unit 5 and a mounting unit 6 which are integrally connected to the sensor housing 4. The sensor unit is not shown and is arranged beneath an optically opaque lens 3 of the dirt guard unit, said lens 3 allowing the passage of electromagnetic radiation of relatively long wavelength.

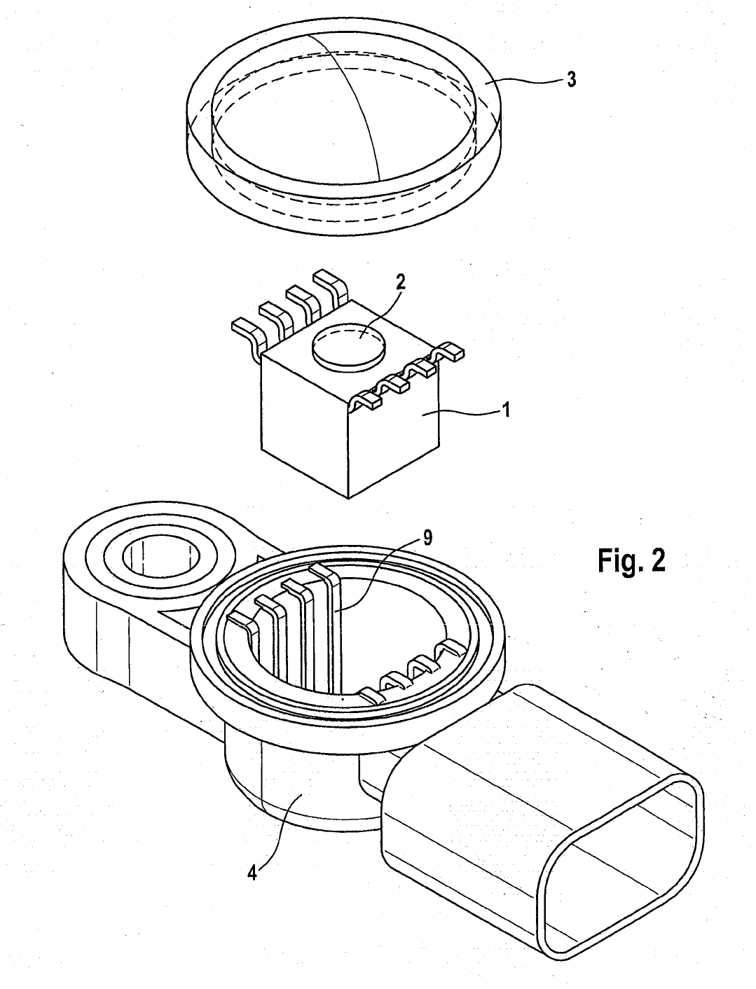

On the basis of the example, FIG. 2 shows the lens 3 of the dirt guard unit, the sensor unit 1 and the sensor housing 4. The sensor housing 4 has a leadframe 9 inserted. On the basis of the example, the sensor unit 1 is the form of an SMD component and has a preliminary optical element 2, which is in the form of a protective disk. The lens 3 is welded to the sensor housing. Furthermore, the sensor unit 1 comprises a radiation emitter element, which is not visible in this Figure, a sensor element and an electronic evaluation circuit.

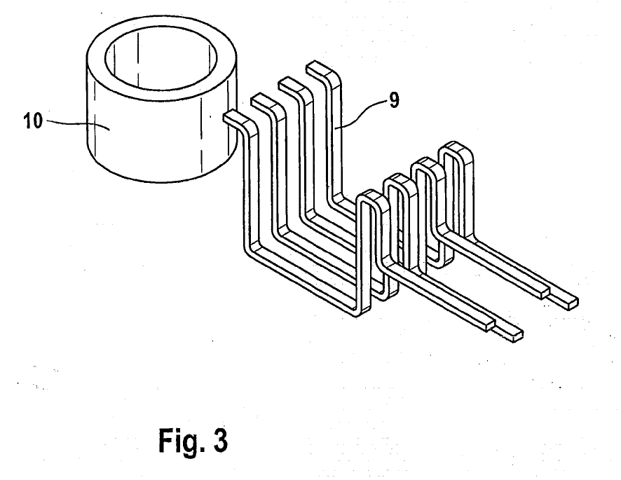

FIG. 3 shows a metal sleeve 10 and a leadframe 9 by way of example for mounting in a sensor housing, not shown. The metal sleeve 10 is integrated into a mounting unit, in particular is injection molded therein, and is used for solidly mounting the housing at the installation location or in the motor vehicle, while the leadframe is used for making contact between a connector unit and a sensor unit.

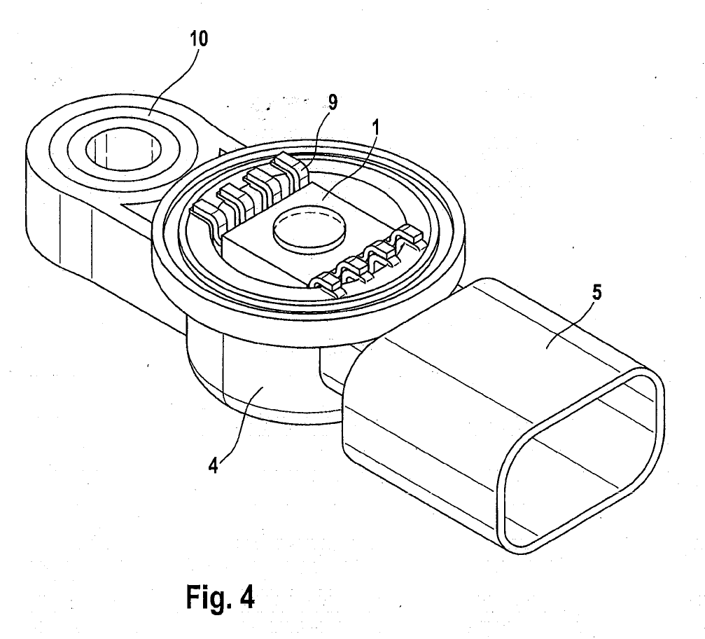

FIG. 4 shows a sensor by way of example without a lens shown, in which the leadframe 9 is injection molded in the sensor housing 4. The sensor unit 1 is in the form of an SMD component and is soldered to the leadframe 9 in the sensor housing. The sensor housing 4 contains a rolled metal sleeve 10 for mounting the sensor at the installation location by means of a screw joint. In addition, the sensor housing contains a connector unit 5 for making electrical contact.

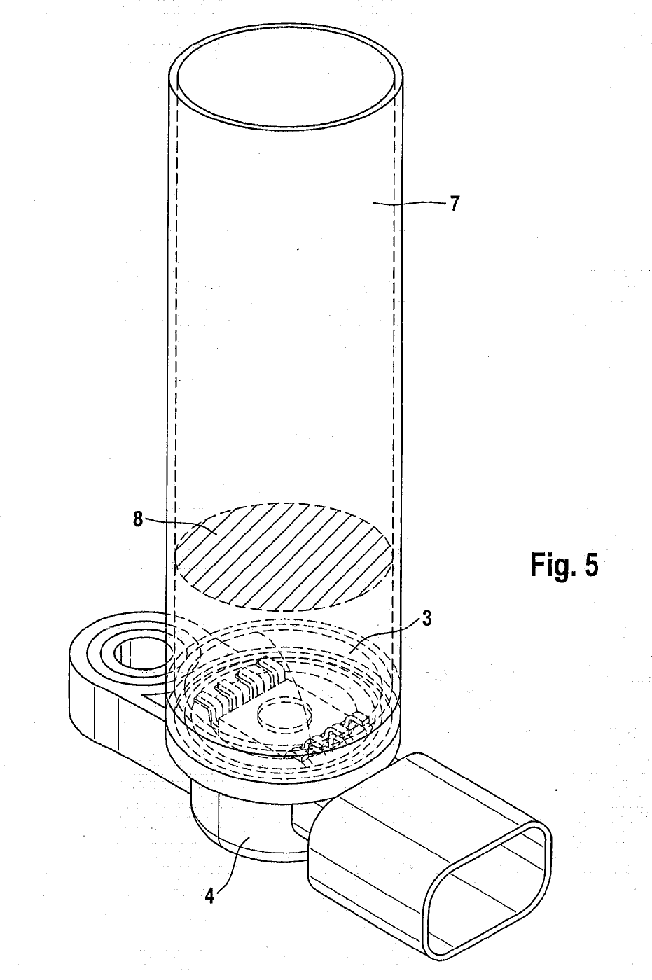

FIG. 5 shows an exemplary embodiment of the sensor with a tube 7, made of plastic, as part of the dirt guard unit. This tube 7 is mounted on a sensor housing 4 by means of detachable mechanical means—not shown. The length of the tube is at least three times as great as the diameter of the lens 3. The tube 7 has a disk 8 as a dirt guard opposite the lens 3, said disk being arranged in the first third of the tube.

1.-11. (canceled)

12. A sensor for sensing speeds, at least comprising a sensor unit, which has a radiation emitter element, a sensor element, a preliminary optical element and an evaluation circuit, a sensor housing, which has a leadframe, and a dirt guard unit, which comprises a lens, wherein the sensor unit is in electrical contact with the leadframe of the sensor housing, and the lens of the dirt guard unit caps off the sensor housing as a cover.

13. The sensor as claimed in claim 12, wherein the lens of the dirt guard unit or the preliminary optical element or the lens of the dirt guard unit and the preliminary optical element are in the form of a liquid lens, particularly with an electrically adjustable focal length.

14. The sensor as claimed in claim 12, wherein the lens of the dirt guard unit or the preliminary optical element or the lens of the dirt guard unit and the preliminary optical element have a liquid crystal layer which can be actuated as an optical closure.

15. The sensor as claimed in claim 12, wherein the sensor unit is in the form of a surface-mounted device.

16. The sensor as claimed in claim 12, wherein the radiation emitter element is in the form of a laser which is designed such that it operates based on a self-modulating interference principle.

17. The sensor as claimed in claim 12, wherein the sensor housing has a mounting unit for mounting the entire sensor, and also a connector unit, the contact pins of which are electrically conductively connected to the leadframe.

18. The sensor as claimed in claim 12, wherein the dirt guard unit comprises a tube.

19. The sensor as claimed in claim 18, wherein the tube is mounted on the sensor housing by means of a mechanically removable and closable closure.

20. The sensor as claimed in claim 19, wherein removable and closable closure is at least one of a clip closure and at least one snap-action clasp.

21. The sensor as claimed in claim 18, wherein the tube contains a disk opposite the lens of the dirt guard unit.

22. The sensor as claimed in claim 12, wherein the sensor unit comprises an electronic self-test device which has an additional sensor element.

23. The use of the sensor as claimed in claim 12 in motor vehicles as an optical speed sensor.
